(19) United States
(12) Patent Application Publication
(10) Pub. No.: US 2026/0341007 A1
(43) Pub. Date: Oct. 29, 2026

(54) IMAGE PROCESSING USING A MACHINE LEARNING SYSTEM FOR OBJECT REMOVAL

(71) Applicant: QUALCOMM Incorporated, San Diego, CA (US)

(72) Inventors: Shreya KADAMBI, San Diego, CA (US); Yifan WANG, San Diego, CA (US); Munawar HAYAT, San Diego, CA (US); Viswesh PARAMESWARAN, San Diego, CA (US); Shubhankar Mangesh BORSE, San Diego, CA (US); Fatih Murat PORIKLI, San Diego, CA (US)

(21) Appl. No.: 19/187,520

(22) Filed: Apr. 23, 2025

(51) Int. Cl. G06V 10/82; G06V 10/75; G06V 10/778

(52) U.S. Cl. CPC G06V 10/82; G06V 10/751; G06V 10/7788

(57) ABSTRACT

Systems and techniques are described herein for image processing. For example, a computing device can process, using an encoder, a first image representation of a scene including an object to determine a first embedding associated with features of the first image representation; process, using the encoder, a second image representation of the scene not including the object to determine a second embedding associated with features of the second image representation; process, using a first machine learning system, the first embedding, the second embedding, a user prompt, and a mask associated with a pixel location of the object represented in the first image representation, to generate a third image representation of the scene not including the object; determine, based on a comparison of the second image representation and the third image representation, a diffusion loss; and adjust parameters of the first machine learning system based on the diffusion loss.

### FIELD

The present disclosure generally relates to machine learning systems. For example, aspects of the present disclosure relate to systems and techniques for image processing using a machine learning system for object removal.

### BACKGROUND

Various image processing techniques can be used by machine learning systems (e.g., machine learning models) to perform object removal from images, such as using diffusion models and generative machine learning systems to generate images (or portions of images) without the object. Object removal can include editing a region of an image by removing an object from the image (e.g., by adjusting pixel values of an image) and populating the region previously occupied by the object with another object or a prediction of a scene in the region previously occupied by the object. For example, machine learning models can be used to generate predictions, based on an image, of the scene behind an object represented in the image, and can remove the object by inpainting the prediction in the region of the image.

Machine learning system architectures, such as neural networks can be used to learn contextual features of images to predict objects or edits to images which should be performed during object removal, such as detecting objects and predicting the features of the environment behind the object. Other machine learning model architectures, such as Generative Adversarial Networks (GANs) can be used to generate edits to the image which can be applied to the image to remove objects (e.g., adjusting pixel values associated with a region of the image including the image). Traditional object removal techniques however can be resource intensive. The resource intensive nature of image processing using machine learning systems can cause traditional machine learning system architectures to be difficult to train and execute on electronic devices where computing resources can be limited, such as on a smartphone, tablet, laptop, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for image processing is provided. The apparatus includes at least one memory and at least one processor coupled to the at least one memory and configured to: process, using an encoder, a first image representation of a scene including an object to determine a first embedding associated with features of the first image representation; process, using the encoder, a second image representation of the scene not including the object to determine a second embedding associated with features of the second image representation; process, using a first machine learning system, the first embedding, the second embedding, a user prompt, and a mask associated with a pixel location of the object represented in the first image representation, to generate a third image representation of the scene not including the object; determine, based on a comparison of the second image representation and the third image representation, a diffusion loss; and adjust parameters of the first machine learning system based on the diffusion loss to provide an adjusted first machine learning system.

In some aspects, an apparatus for image processing is provided. The apparatus includes at least one memory and at least one processor coupled to the at least one memory and configured to: process a first image of a first scene including a first object and a user prompt requesting removal of the first object from the first image using a first machine learning system, wherein the first machine learning system is trained based on a comparison of a first image representation and a second image representation, wherein the first image representation represents a second scene not including a second object and the second image representation is a predicted representation of the first image representation based on an image including the second object, a second user prompt, and a mask, and wherein the comparison is used to determine a diffusion loss to train the first machine learning system; and generate a second image, the second image including the first scene with the first object removed.

In some aspects, a method for image processing is provided. The method includes: processing, using an encoder, a first image representation of a scene including an object to determine a first embedding associated with features of the first image representation; processing, using the encoder, a second image representation of the scene not including the object to determine a second embedding associated with features of the second image representation; processing, using a first machine learning system, the first embedding, the second embedding, a user prompt, and a mask associated with a pixel location of the object represented in the first image representation, to generate a third image representation of the scene not including the object; determining, based on a comparison of the second image representation and the third image representation, a diffusion loss; and adjusting parameters of the first machine learning system based on the diffusion loss to provide an adjusted first machine learning system.

In some aspects, a method for image processing is provided. The method includes: processing a first image of a first scene including a first object and a user prompt requesting removal of the first object from the first image using a first machine learning system, wherein the first machine learning system is trained based on a comparison of a first image representation and a second image representation, wherein the first image representation represents a second scene not including a second object and the second image representation is a predicted representation of the first image representation based on an image including the second object, a second user prompt, and a mask, and wherein the comparison is used to determine a diffusion loss to train the first machine learning system; and generating a second image, the second image including the first scene with the first object removed.

In some aspects, a non-transitory computer-readable medium is provided having stored thereon instructions that, when executed by at least one processor, cause the at least one processor to: process, using an encoder, a first image representation of a scene including an object to determine a first embedding associated with features of the first image representation; process, using the encoder, a second image representation of the scene not including the object to determine a second embedding associated with features of the second image representation; process, using a first machine learning system, the first embedding, the second embedding, a user prompt, and a mask associated with a pixel location of the object represented in the first image representation, to generate a third image representation of the scene not including the object; determine, based on a comparison of the second image representation and the third image representation, a diffusion loss; and adjust parameters of the first machine learning system based on the diffusion loss to provide an adjusted first machine learning system.

In some aspects, a non-transitory computer-readable medium is provided having stored thereon instructions that, when executed by at least one processor, cause the at least one processor to: process a first image of a first scene including a first object and a user prompt requesting removal of the first object from the first image using a first machine learning system, wherein the first machine learning system is trained based on a comparison of a first image representation and a second image representation, wherein the first image representation represents a second scene not including a second object and the second image representation is a predicted representation of the first image representation based on an image including the second object, a second user prompt, and a mask, and wherein the comparison is used to determine a diffusion loss to train the first machine learning system; and generate a second image, the second image including the first scene with the first object removed.

In some aspects, an apparatus for image processing is provided. The apparatus includes: means for processing, using an encoder, a first image representation of a scene including an object to determine a first embedding associated with features of the first image representation; means for processing, using the encoder, a second image representation of the scene not including the object to determine a second embedding associated with features of the second image representation; means for processing, using a first machine learning system, the first embedding, the second embedding, a user prompt, and a mask associated with a pixel location of the object represented in the first image representation, to generate a third image representation of the scene not including the object; means for determining, based on a comparison of the second image representation and the third image representation, a diffusion loss; and means for adjusting parameters of the first machine learning system based on the diffusion loss to provide an adjusted first machine learning system.

In some aspects, an apparatus for image processing is provided. The apparatus includes: means for processing a first image of a first scene including a first object and a user prompt requesting removal of the first object from the first image using a first machine learning system, wherein the first machine learning system is trained based on a comparison of a first image representation and a second image representation, wherein the first image representation represents a second scene not including a second object and the second image representation is a predicted representation of the first image representation based on an image including the second object, a second user prompt, and a mask, and wherein the comparison is used to determine a diffusion loss to train the first machine learning system; and means for generating a second image, the second image including the first scene with the first object removed.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SoC), in accordance with aspects of the present disclosure.

FIG. 2 is a block diagram illustrating an example end-to-end pipeline for training a machine learning system using counterfactual images, in accordance with aspects of the present disclosure.

FIG. 3 is a block diagram illustrating an example of training data 300 which can be used to train a machine learning system, in accordance with aspects of the present disclosure.

FIG. 4 is a block diagram illustrating training a machine learning system based on a transitive consistency loss determined performing bi-direction editing, in accordance with aspects of the present disclosure.

FIG. 5 is a flow diagram illustrating an example process of image processing, in accordance with aspects of the present disclosure.

FIG. 6 is a block diagram illustrating an example neural network, in accordance with aspects of the present disclosure.

FIG. 7 is a block diagram illustrating an example convolutional neural network, in accordance with aspects of the present disclosure.

FIG. 8 is a block diagram of an example transformer in accordance with aspects of the disclosure.

FIG. 9 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As previously mentioned, various image processing techniques can be used by machine learning systems (e.g., machine learning models) to perform object removal from images, such as using diffusion machine learning models and generative machine learning systems to generate images (or portions of images) without the object. Object removal can include editing a region of an image by removing an object from the image (e.g., by adjusting pixel values of an image) and populating the region previously occupied by the object with another object or a prediction of a scene in the region previously occupied by the object. For example, machine learning models can be used to generate predictions, based on an image, of the scene behind an object represented in the image, and can remove the object by inpainting the prediction in the region of the image.

Machine learning system architectures, such as neural networks can be used to learn contextual features of images to predict objects or edits to images which should be performed during object removal, such as detecting objects and predicting the features of the environment behind the object. Other machine learning model architectures, such as Generative Adversarial Networks (GANs) can be used to generate edits to the image which can be applied to the image to remove objects (e.g., adjusting pixel values associated with a region of the image or pixel location including the image). Traditional object removal techniques however can be resource intensive. The resource intensive nature of image processing using machine learning systems can cause traditional machine learning system architectures to be difficult to train and execute on electronic devices where computing resources can be limited, such as on a smartphone, tablet, laptop, etc.

Object removal techniques can include editing areas of images to replace objects with a prediction of the scene or environment behind the object represented in the image. For example, the object (e.g., the occluding object) can partially occlude another object (e.g., the occluded object). In such an example, object removal techniques can include determining features associated with the occluded object and editing the image to include predictions of features of the occluded object covered by the occluding object. In some examples, object removal can include blending portions of images into an area of the image where the object was removed. Further examples of inpainting can include using diffusion machine learning models, transformer architecture, neural networks, generative machine learning models, GANs, etc. to predict features of an environment or scene, and to edit the image based on the predicted features. In some examples, object removal techniques can be requested by users, such as through a user prompt. For example, various generative machine learning models can receive user prompts requesting performance of an edit, such as removing an object from an image.

Training and executing machine learning models can be resource intensive. Many computing devices (e.g., smartphones, laptops, tablets, etc.) lack the computational resources to efficiently execute machine learning models for performing object removal techniques. Generally, to bypass the computational resource constraints of computing devices such as smartphones, the computing devices can communicate with edge devices, servers, services, or other computing devices, to perform object removal techniques. In such examples, the computing device can transmit an image to the edge device, server, etc. and can receive an edited image back from the edge device. This alternative can introduce security concerns for users seeking to edit images the users prefer not to share with another device or off-device machine learning system. For example, users concerned about personally identifiable information (PII), or biometric information being stored or being used to train off-device machine learning systems may avoid off-device solutions for object removal (or other image processing solutions) because of concerns for privacy and security. Improvements to the operation of machine learning systems can allow for more machine learning systems to be operated on devices with lower computational constraints (e.g., devices having lower processing power, lower computational resources, etc.). Improvements to the operation of machine learning systems can further allow more accurate machine learning systems to be executed using computing devices.

Systems, apparatuses, electronic devices, methods (also referred to as processes), and computer-readable media (collectively referred to herein as “systems and techniques”) are described herein for performing object removal using machine learning systems. The systems and techniques can include various machine learning model architectures (also referred to as machine learning system architectures or machine learning model architectures) such as a U-Net neural network architecture (e.g., a U-Net convolutional neural network (CNN) architecture). The systems and techniques can include multiple machine learning systems (also referred to herein as machine learning models) such as a machine learning system to generate masks and a machine learning system to perform the object removal.

In some aspects, the systems and techniques can include training techniques for training machine learning systems using factual and counterfactual images. Factual images can include images including an object to be removed from the image. Counterfactual images can refer to images which do not include the object which is to be removed from the image. Factual and counterfactual images can correspond to the other. For example, a factual image can include a corresponding counterfactual image. In such an example, the factual image can represent a scene (or environment) including an object, such as an apple on top of a plate. The counterfactual image can be the same or substantially the same image as the factual image with the apple removed from the image. In such an example, the counterfactual image can differ from the factual image at a region of the factual image which includes the object to be removed. The systems and techniques can include training techniques for training machine learning systems using images with objects removed (e.g., the counterfactual images).

In some cases, the machine learning systems can include diffusion machine learning models, such as a stable diffusion model. For example, the machine learning systems can process images including noise to generate denoised representations of the images. In one example, the machine learning systems can apply noise (e.g., applying a noise distribution such as a random distribution of noise) to images input to the machine learning systems. For example, the machine learning systems can apply noise such as a random noise distribution or random Gaussian noise distribution to images. In further examples, various engines, programs, or services can apply the noise to the images and the noisy image (e.g., the image including the noise) can be processed by the machine learning systems.

In one example of training a diffusion machine learning model (also referred to as a diffusion model) for object removal, the factual image (also referred to in this example as a source image) can be represented as x₀ₛ. The systems and techniques can include applying noise to the source image, as represented by ϵₜ~N(0, σₜ²). In such an example, the noised source image (e.g., the source image including the noise) can be represented as x₀ₛ+ϵₜ(0, t) where t is associated with a timestep representing an amount of noise applied to the source image. In such an example, the noised source image can be provided to the diffusion model to generate an image with an object removed from the image. In such an example, the image generated by the diffusion model can be compared to a counterfactual image associated with the source image to determine a diffusion loss associated with the diffusion model. In further examples, the diffusion model can output an embedding representation of an image with the object removed from the image. The systems and techniques can include adjusting parameters of the diffusion model based on the diffusion loss to train the diffusion model to reduce a loss function.

In some examples, the diffusion model can be a conditional diffusion model. For example, the diffusion model can receive the noised source image, a mask, and a user prompt. The user prompt can include a text-based request to perform an action, such as a request to remove an object. The mask can be a matrix representation of binary values (e.g., 0s and 1s) associated pixels of the image indicating a location of the object to be removed from the noised source image.

In some aspects, the systems and techniques can include using counterfactual images as inputs to a machine learning system (such as a diffusion machine learning system or diffusion machine learning system). In an example, the machine learning system can receive a counterfactual image as input to the machine learning system. In such an example, the counterfactual image can be represented as x₀ₜ. In such an example, a noised representation of the counterfactual image can be represented as x₀ₜ+ϵₜ(0, t). The noised representation of the of the counterfactual image can be provided as input to the machine learning system.

The machine learning system can process the noised representation of the counterfactual image and conditions to the machine learning system (e.g., a user prompt requesting removal of an object and a mask) to denoise the noised representation of the counterfactual image. For example, denoising the noised representation of the counterfactual image can provide an approximation of the counterfactual image (e.g., a counterfactual image including errors). The approximation of the counterfactual image (or embedding representation thereof) can be compared to the counterfactual image to determine a diffusion loss associated with the machine learning system. The systems and techniques can include adjusting parameters (e.g., weights) of the machine learning system to reduce a loss function of the machine learning system.

In some aspects, the machine learning system can be pretrained using a plurality of user prompts. In such an example, the machine learning system can include a plurality of user prompts including text-based requests for the removal of people and objects from an image. For example, a user prompt can include “remove the woman from the image.” The plurality of user prompts can include user prompts not requesting removal of the objects from the images. For example, the user prompts can be unrelated to removal of the objects. In one such example, the user prompts can include requests to perform other image processing techniques such as editing an image by adjusting lighting conditions, adding objects, etc. In further examples, the user prompts can be unrelated to image processing or blank (e.g., empty user prompts not including any text-based requests). For example, the user prompt can refer to a task to be performed on the image (e.g., removal, addition or manipulating concepts such as lightning or removing rain drops from windshield, etc.).

In some examples, the majority of the user prompts used to train the machine learning system can be empty prompts, such as prompts that do not request removal of the objects from the images. In one non-limiting example, ~60% of the user prompts used to train the machine learning system can be empty prompts.

In some examples, the machine learning system can be part of an end-to-end object removal training pipeline. For example, the systems and techniques can include providing an input factual image (e.g., an image or image representation of a scene including an object) and a counterfactual image associated with or corresponding to the input factual image to an encoder. In some examples, the counterfactual image and the factual image can be provided to different encoders. The encoder can include a variational encoder (VaE) of a machine learning system. In some examples, the encoder can be associated with the machine learning system to perform object removal (e.g., the encoder can be a component of the machine learning system). In further examples, the encoder can be associated with a separate machine learning system.

The encoder can process the counterfactual image and the factual image to generate a first embedding associated with features (e.g., source latents) of the factual image and a second embedding associated with features (e.g., target latents) of the counterfactual image. The systems and techniques can include applying noise to the first embedding and the second embedding. The machine learning system can receive the first embedding and the second embedding. In such an example, the machine learning system can process the first embedding, the second embedding, a user prompt, and a mask to generate an image representation of the scene represented in the factual image not including the object. The systems and techniques can include comparing the generated image representation to the counterfactual image to determine a diffusion loss associated with the machine learning system (e.g., based on a comparison of the generated image representation to the counterfactual image). The systems and techniques can include adjusting parameters of the machine learning system to reduce a loss function of the machine learning system.

In some examples, a second machine learning system can be used to generate the mask. For example, the factual image can be provided to a segmentation machine learning system to generate a mask associated with the object to be removed from the factual image. In further examples, the mask can be generated using a mask generator, application, or service. For example, the segmentation machine learning system to identify borders of the object within the factual image. The segmentation machine learning system can generate a matrix of binary values corresponding to pixels of the factual image. In such an example, the matrix can indicate pixels of the factual image within the borders of the object represented in the factual image. In some examples, the second machine learning system (e.g., the segmentation machine learning system) can use various object recognition or object detection techniques to identify objects within the factual image requested in a user prompt to be removed from the factual image.

In some aspects, the systems and techniques can include further training the machine learning system using transitive consistency loss of performing bi-directional editing of the counterfactual images and factual images. For example, the combined loss of the diffusion loss associated with the counterfactual image and the transitive consistency loss associated with the bi-directional editing can be represented as

$$ℒ = {∇}_{θ} {‖ {ϵ}_{θ}^{y} - {ϵ}_{y} ‖}_{2}^{2} + {∇}_{θ} {‖ {ϵ}_{θ}^{\tilde{y} x} - \text{?} - {ϵ}_{x} - {ϵ}_{y} ‖}_{2}^{2} .$$

In such an example, the diffusion loss can be represented as

$${∇}_{θ} {‖ {ϵ}_{θ}^{y} - {ϵ}_{y} ‖}_{2}^{2}$$

and the transitive consistency loss can be represented as

$${∇}_{θ} {‖ {ϵ}_{θ}^{\tilde{y} x} - \text{?} - {ϵ}_{x} - {ϵ}_{y} ‖}_{2}^{2} .$$

The systems and techniques can include using the machine learning system (the machine learning system pre-trained using the diffusion losses, also referred to as the adjusted machine learning system or the adjusted first machine learning system) to process a factual image to generate a counterfactual image with an object of the factual image removed. In some examples, the factual image can be represented as xₜ=\sqrt{α̅ₜ}x₀+ϵₓ\sqrt{1−α̅ₜ̅}.

In some examples, the machine learning system can process the factual image and a user prompt (represented by c_{y}) to generate a predicted counterfactual image (e.g., a predicted representation of the counterfactual image or predicted image representation). In some examples, the predicted counterfactual image can be represented as

$${y}_{0 ( t )} = \frac{1}{\sqrt{{α}_{t}}} ( {x}_{s t} - \sqrt{1 - \overline{{α}_{t}}} {ϵ}_{θ} ( {x}_{st} , {c}_{y} ) ) .$$

The machine learning image can process the predicted counterfactual image using the machine learning system to determine a predicted factual image. In some examples, the machine learning system can process the predicted factual image and an example user prompt, represented as cx, requesting the object be inserted into the predicted counterfactual image. In such an example, α̅ₜ̅ is noise schedule for timestep t.

In some aspects, the systems and techniques can include comparing the predicted factual image and the factual image to determine a transitive consistency loss associated with the machine learning system (e.g., based on a comparison of the predicted factual image and the factual image). The systems and techniques can include adjusting parameters of the machine learning system based on the transitive consistency loss to reduce a loss function. In some examples, the training process can use a counterfactual image. In such an example, the machine learning system can process the counterfactual image to generate a predicted factual image. The machine learning system can process the predicted factual image to determine a predicted counterfactual image. In such an example, the systems and techniques can include comparing the predicted counterfactual image and the counterfactual image to determine the transitive consistency loss. The systems and techniques can include adjusting the machine learning system based on the transitive consistency loss to reduce a loss function.

Various aspects of the present disclosure will be described with respect to the figures.

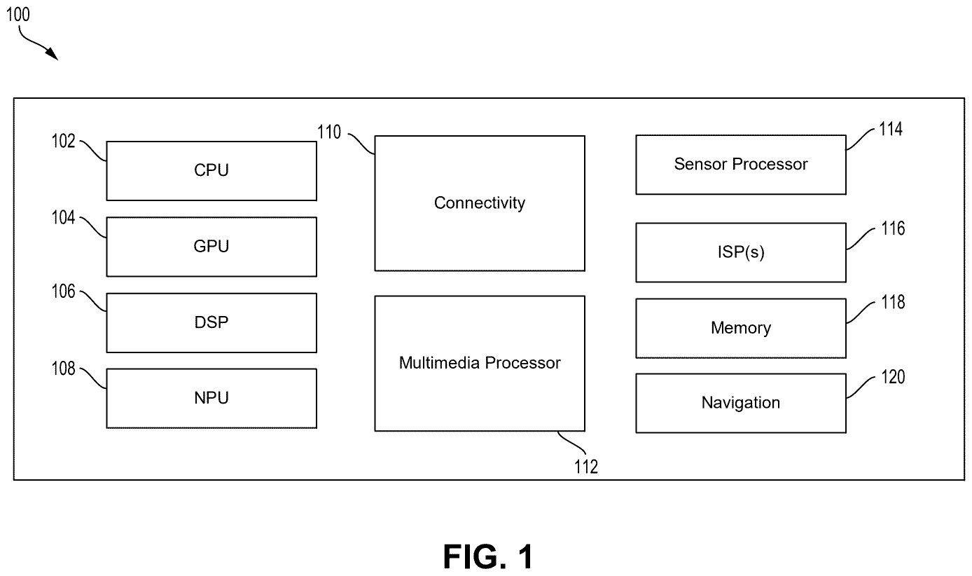

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize audio signals. In one implementation, the NPU is implemented in the CPU 102, DSP 106, and/or GPU 104. The SOC 100 may also include one or more sensors 114 such as but not limited to one or more microphones, image signal processors (ISPs) 110, and/or storage 120.

The SOC 100 may be based on an ARM instruction set. In an aspect of the present disclosure, the instructions loaded into the CPU 102 may comprise code to search fora stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured generate explanations for actions performed (e.g., to be performed, predicted to be performed, etc.) by a machine learning model. The explanations can be one or more of a text-based description, set of instructions to perform a sub-task or task, etc. according to aspects of the present disclosure discussed herein. The SOC can be used to operate various machine learning models for image processing, text processing, feature extraction, signal controls generation, etc. For example, SOC 100 and/or components thereof may be configured to perform processing techniques such as but not limited to: segment shifting, shuffle correlation, gain shifting, segment masking, and additional processing techniques. SOC 100 can be part of a computing device or multiple computing devices. In some examples, SOC 100 can be part of an electronic device (or devices) such as an audio recording device, camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

For example, the use of recurrent connections and/or temporal information in a machine learning model for inpainting, such as denoising of images and adding objects to areas of the image, can be used to preserve characteristics of the image including noise, to achieve higher quality images (e.g., denoised images and images including the inpainting). Various recurrent architectures (e.g., RNNs) that include one or more recurrent cells among the feed-forward layers of the network can be used to perform audio processing operations to generate processed output audio signals having a relatively high quality. For example, recurrent cells can be implemented using a vanilla-RNN architecture, a Conv-GRU (Gated Recurrent Unit) architecture, a Conv-LSTM (Long Short-Term Memory) architectures, among various others.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of audio can benefit from first learning to recognize individual spoken words, instruments in music, etc. These features may be combined at higher layers in different ways to recognize sounds such as speech, instruments, wind noise, etc.

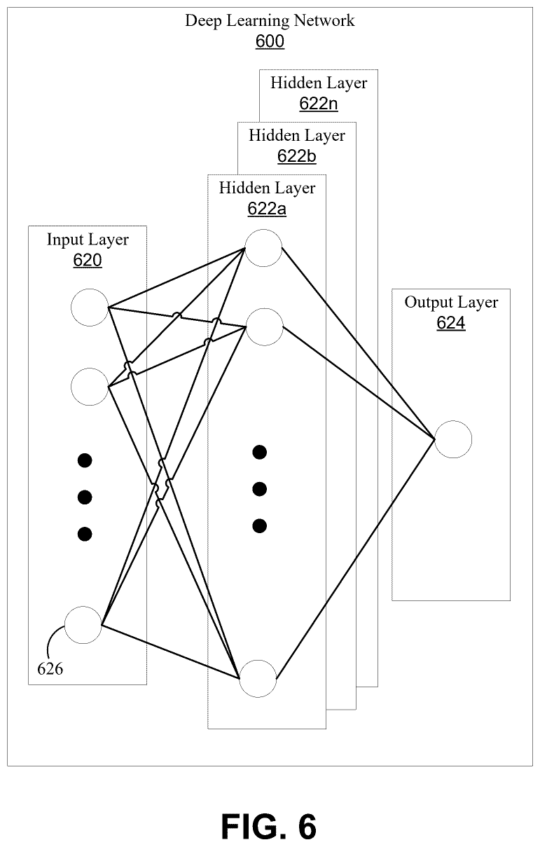

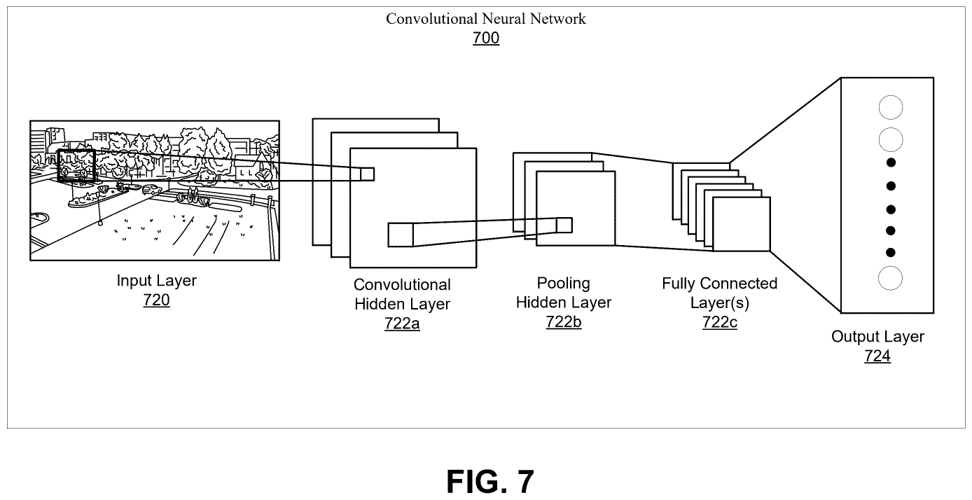

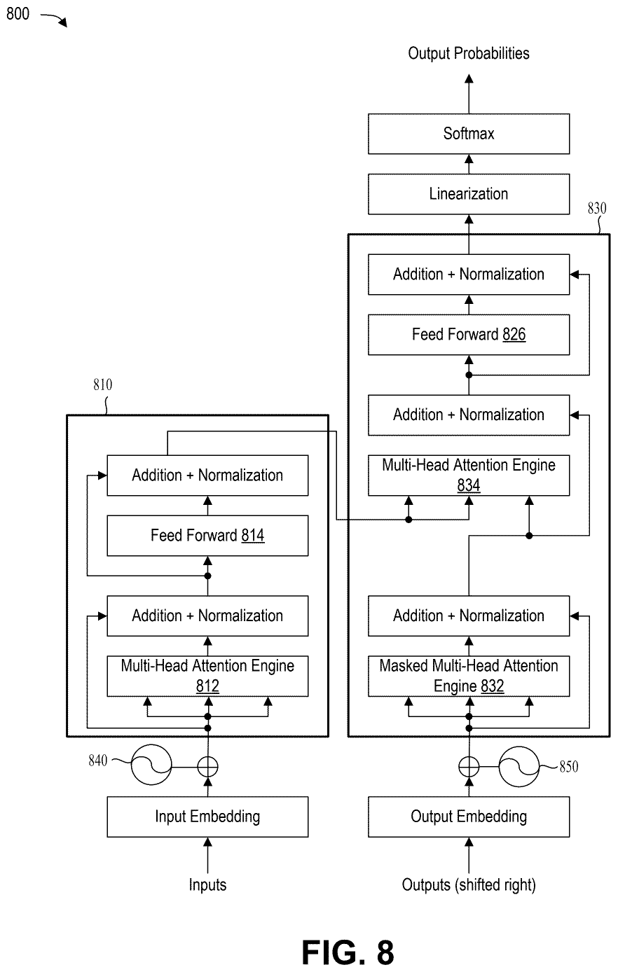

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. Further description of machine learning model architecture is provided in the description of FIG. 6, FIG. 7, and FIG. 8.

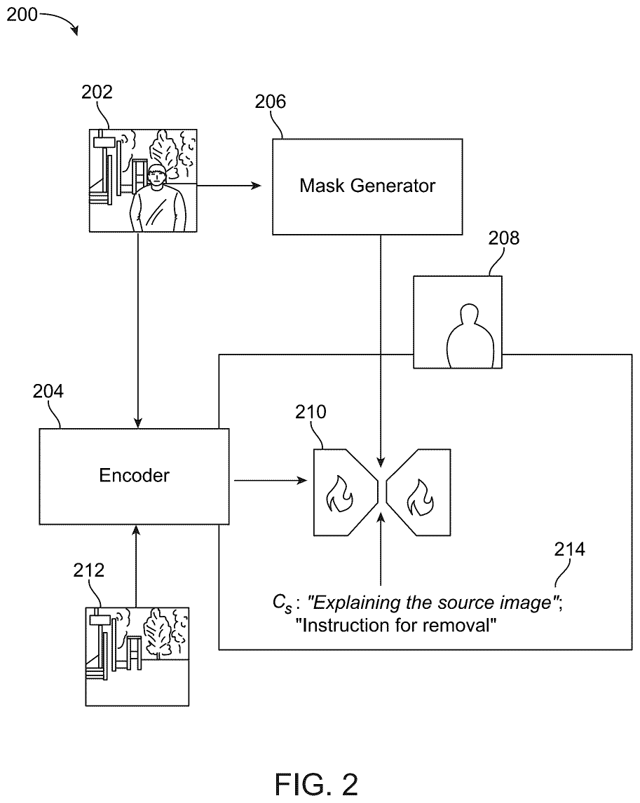

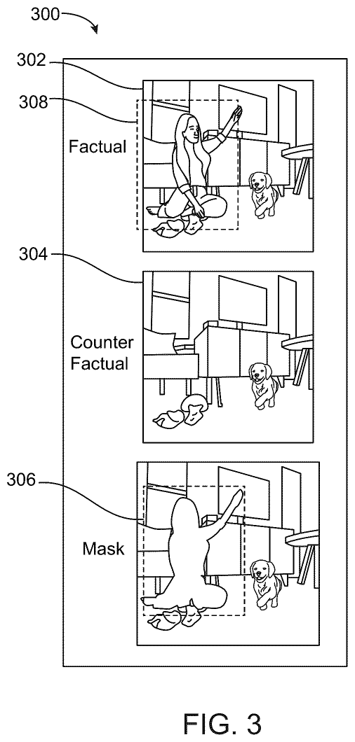

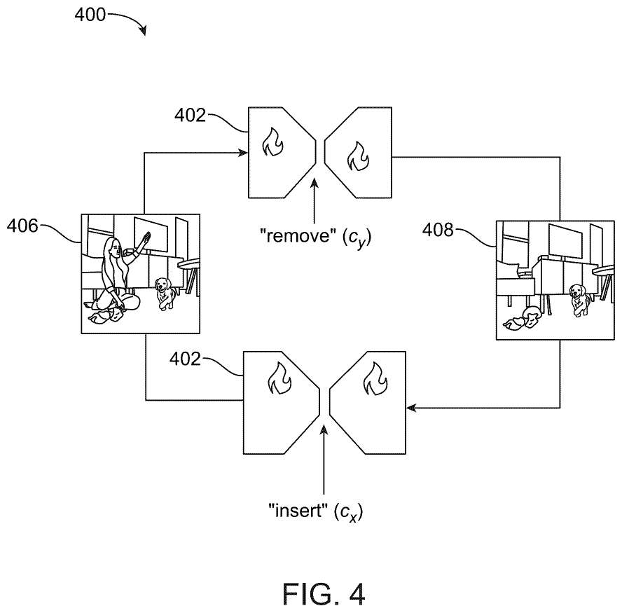

The SOC 100 of FIG. 1 can be used to perform the various systems and techniques described in the descriptions of FIG. 2-FIG. 5. For example, the SOC 100 can be used to perform operations of the machine learning systems described in the description of FIG. 2, FIG. 3, and FIG. 4 including object removal and training techniques.

FIG. 2 is a block diagram illustrating an example end-to-end pipeline 200 for training a machine learning system using counterfactual images. The pipeline 200 can include an encoder 204, a mask generator 206, and a machine learning system 210.

The pipeline 200 can receive a factual image 202 and a counterfactual image 212. The factual image 202 can depict a scene including an object or person. The counterfactual image 212 can correspond to the factual image 202, such as by depicting the scene without the object or person. In some examples, the counterfactual image 212 can be an image generated using another object removal machine learning system. In further examples, the counterfactual image and the factual image can be training data from a set of training data used to train the machine learning system 210.

The encoder 204 can receive the counterfactual image 212 and the factual image 202. The encoder 204 can process the counterfactual image 212 and the factual image 202 to generate embedding representations of the counterfactual image 212 and the factual image 202. In some examples, the encoder 204 can include a variational encoder (VaE). In further examples, the encoder 204 can include multiple encoders. For example, the counterfactual image 212 can be processed using a first encoder and the factual image 202 can be processed using a second encoder.

The encoder 204 can output embedding representations of the factual image 202 and the counterfactual image 212 (e.g., a first embedding and a second embedding). In some examples, the encoder 204 can be associated with the machine learning system 210 to perform object removal (e.g., the encoder 204 can be a component of the machine learning system 210). In further examples, the encoder 204 can be associated with a separate machine learning system.

The mask generator 206 can receive the factual image 202 and generate a mask 208 associated with the factual image 202. For example, the mask generator 206 can be a machine learning system, application, function, algorithm, service, etc. to identify objects within the factual image 202. The mask generator 206 can identify objects within the factual image 202 and generate a mask based on the position of the objects (e.g., one or more objects to be removed). For example, the mask generator 206 can determine pixel values of the factual image 202 which should be edited to remove the object based on boundaries of the object represented in the factual image 202.

In some examples, the mask 208 can be a matrix of binary values (e.g., 0s and 1s). The binary values can correspond to individual pixels, groups of pixels, or pixel locations of an object represented in an image (e.g., the mask 208 and the factual image 202 can have the same or different resolutions). For example, is of the matrix can indicate pixels corresponding to the is from the factual image 202 are associated with the object to be removed.

In some examples, the machine learning system 210, the encoder 204, or another component of the pipeline 200 can add noise to the embedding representations of the factual image 202 and the counterfactual image 212 (e.g., the first embedding and the second embedding). The noise can include a random noise distribution such as a random Gaussian noise distribution. The machine learning system 210 can process the embedding representations with the noise, the mask 208, and a user prompt 214 to determine a predicted counterfactual image.

The user prompt 214 can include a user request to perform an action, such as a request to remove an object from the factual image 202. In some examples, the user prompt 214 can include a text-based request to remove the object. In such an example, the text-based request can include a statement such as “remove the man from the image.” In some examples, the user prompt 214 can also be received by the mask generator 206 to identify the object from the factual image 202 to remove. In other examples, the mask 208, the factual image 202, the user prompt 214, and the counterfactual image 212 can be included in a training data set for training the machine learning system 210.

The predicted counterfactual image can be an image (or image representation) generated by the machine learning system 210 approximating the counterfactual image 212. The machine learning system 210, or a training engine, can compare the predicted counterfactual image and the counterfactual image 212 to determine a loss (e.g., a diffusion loss) associated with the machine learning system 210. For example, the predicted counterfactual image can include differences from the counterfactual image 212. In such an example, the predictions can be associated with a region of the factual image 202 from which the object was removed. Parameters (e.g., weights) of the machine learning system 210 can be adjusted based on the loss to reduce a loss function.

FIG. 3 is a block diagram illustrating an example of training data 300 which can be used to train a machine learning system, such as the machine learning system 210 of FIG. 2. The block diagram includes a factual image 302, a counterfactual image 304, and a mask 306.

Factual images such as factual image 302 are images (or image representations) including an object 308 (or as depicted in FIG. 3, a person) to be removed from the image. Counterfactual images, such as counterfactual image 304 can include images which do not include the object 308 which is to be removed from the image. For example, counterfactual images can include images which have already had the object removed from the image. Factual and counterfactual images can correspond to the other. For example, the factual image 302 can include a corresponding counterfactual image 304. In such an example, the factual image 302 can represent a scene with an object (e.g., the object 308) or person, such as the person depicted in the factual image 302. The counterfactual image 304 can be the same or substantially the same image as the factual image 302 with the object 308 removed from the image. In such an example, the counterfactual image 304 can differ from the factual image 302 at a region of the factual image which includes the object to be removed.

The mask 306 can be represented as a matrix of binary values corresponding to pixels of the factual image. The mask 306 can indicate, based on the values of the matrix, which pixels of the factual image 302 correspond to the object 308. In some examples, the mask 306 can be predetermined based on the factual image 302. In further examples, a machine learning system (or a mask generator such as the mask generator 206 of FIG. 2) can generate the mask based on the factual image 302. For example, a machine learning system can use various object recognition or object detection techniques to identify objects within the factual image 302. In some examples, the training data 300 can include predetermined user prompts. For example, the user prompts can be text-based requests to remove objects from factual images.

FIG. 4 is a block diagram 400 illustrating training a machine learning system 402 based on a transitive consistency loss determined performing bi-direction editing of counterfactual images and factual images. For example, the machine learning system 402 can be a pre-trained machine learning system, such a machine learning system trained based on diffusion losses. For example, the machine learning system 402 can be the machine learning system 210 of FIG. 2 trained based on diffusion losses.

For example, the block diagram 400 illustrates an example of training technique of further training the machine learning system 402 based on changes to counterfactual images 408 and factual images 406 generated by the machine learning system 402. In one example, the machine learning system 402 can receive a factual image 406 and a user prompt requesting the machine learning system 402 remove an object from the factual image 406. The machine learning system 402 can process the factual image 406 and the user prompt to generate a counterfactual image 408. The counterfactual image 408 can be a predicted counterfactual image 408 (e.g., a counterfactual image 408 where the region associated with the removed object is predicted by the machine learning system 402).

The machine learning system 402 can receive the counterfactual image 408 and a user prompt requesting the machine learning system 402 add back the removed object from the factual image 406. In such an example, the machine learning system 402 can process the counterfactual image 408 to generate an additional factual image. The additional factual image can be a predicted factual image (e.g., a factual image 406 where the object is added to a counterfactual image based on predictions of a machine learning system).

The machine learning system 402, or a training engine, can compare the factual image 406 and the counter factual image to determine a loss between the images (e.g., a transitive consistency loss). Parameters of the machine learning system 402 can be adjusted based on the transitive consistency loss to reduce a loss function. In some examples, the machine learning system 402 can use a counterfactual image as the initial image (as opposed to starting the training with a factual image such as factual image 406) to train the machine learning system 402. In such an example, the machine learning system can process the counterfactual image 408 to generate a predicted factual image. The machine learning system can process the predicted factual image to determine a predicted counterfactual image. In such an example, the machine learning system 402 can compare the predicted counterfactual image and the counterfactual image to determine the transitive consistency loss.

In some aspects, training of one or more of the machine learning systems or neural networks described herein (e.g., such as the machine learning systems of FIG. 2, FIG. 3, FIG. 4, among various other machine learning networks and models described herein) can be performed using online training (e.g., in some case on-device training), offline training, and/or various combinations of online and offline training. In some cases, online can refer to time periods during which the input data (e.g., such as the sensor data, images, masks) is processed, for example for performance of optimizing loss weights of the loss function to reduce losses while maintaining accuracy of the neural network. In some examples, offline can refer to idle time periods or time periods during which input data is not being processed. Additionally, offline can be based on one or more time conditions (e.g., after a particular amount of time has expired, such as a day, a week, a month, etc.) and/or can be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

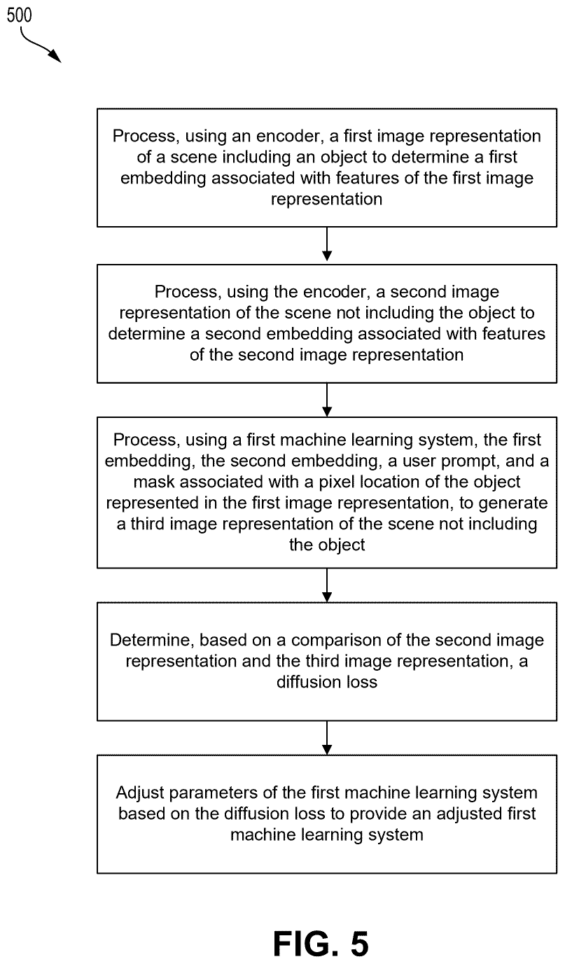

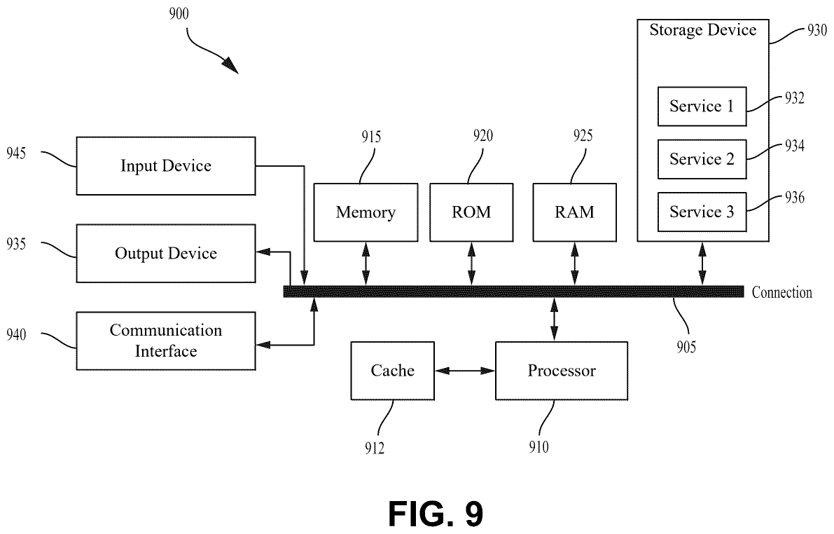

FIG. 5 is a flow diagram illustrating an example process 500 for image processing. The process 500 can be performed by a computing device (e.g., SOC 100 of FIG. 1, computing device or computing system 900 of FIG. 9, etc.) or by a component or system (e.g., the machine learning systems of FIG. 2, the machine learning systems of FIG. 4, etc.), a chipset, one or more processors central processing units (CPUs), digital signal processors (DSPs), graphics processing units (GPUs), any other type of processor(s), any combination thereof, or other component or system) of the computing device. The operations of the process 500 can be implemented as software components that are executed and run on one or more processors (e.g., processor 910 of FIG. 9 or other processor(s)) of the computing device. Further, the transmission and reception of signals by the computing device in the process 500 can be enabled, for example, by one or more antennas, one or more microphones, and/or one or more transceivers (e.g., wireless transceiver(s)).

At block 502, the computing device (or component thereof) can process, using an encoder, a first image representation of a scene including an object to determine a first embedding associated with features of the first image representation. For example, the first image representation of the scene can be processed using a variational encoder (VaE) of a machine learning system. In some examples, the machine learning system can be a separate machine learning system from the first machine learning system used to process the user prompt at block 506.

At block 504, the computing device (or component thereof) can process a second image representation of the scene not including the object to determine a second embedding associated with features of the second image representation. In some examples, the computing device (or component thereof) can use an encoder to process the second image representation. In further examples, the encoder can be a different encoder than the encoder used to process the first image representation. For example, the encoder can be a different variational encoder from the encoder used to process the first image representation. In some examples, the first embedding and the second embedding include a random distribution of noise applied to each embedding.

At block 506, the computing device (or component thereof) can process the first embedding, the second embedding, a user prompt, and a mask associated with a pixel location of the object represented in the first image representation, to generate a third image representation of the scene not including the object. In such an example, the computing device (or component thereof) can process the first embedding, the second embedding, the user prompt, and the mask using a machine learning network. In further examples, the first machine learning system includes a diffusion machine learning system using U-Net neural network architecture. In another example, the first machine learning system can be trained using a plurality of user prompts. In such an example, the plurality of user prompts can include user prompts requesting removal of objects from images and user prompts not requesting removal of objects from the images. In such an example, the plurality of user prompts can include empty user prompts (e.g., prompts not requesting removal of the objects). In some examples, the majority of the user prompts used to train the first machine learning system do not request removal of the objects from the images. For example, the majority of the user prompts can be empty user prompts. In such an example, the empty user prompts can be included in the plurality of user prompts to prevent overfitting of the outputs of the machine learning system trained using the user prompts.

At block 508, the computing device (or component thereof) can determine, based on a comparison of the second image representation and the third image representation, a diffusion loss. For example, the third image representation can be a predicted counterfactual image can include differences from the second image representation (e.g., a counterfactual image used as a ground truth). In some examples, the diffusion loss can be associated with a region of the second image from which the object was removed.

At block 510, the computing device (or component thereof) can adjust parameters of the first machine learning system based on the diffusion loss to provide an adjusted first machine learning system. For example, the computing device (or component thereof) can use backpropagation to adjust weights and parameters of the first machine learning system to reduce a loss function. In some examples, the computing device (or component thereof can process the first image representation to identify the object from the scene using a second machine learning system. For example, the second machine learning system can be an object detection model for detecting objects from images (e.g., from images, image representations, etc.). In such an example, the computing device (or component thereof) can generate the mask based on the pixel location of the object represented in the first image representation. The training can be performed on-device. In some examples, the training can be performed on a server or other device. In such an example, a pre-trained machine learning system can be deployed to a computing device.

In some examples, the computing device (or component thereof) can train a machine learning system (e.g., the first machine learning system) based on a transitive consistency loss determined performing bi-direction editing of counterfactual images and factual images, as further described in the description of FIG. 4. In some examples, the training based on transitive consistency loss can be in addition to training using the diffusion loss. For example, the adjusted first machine learning system can process a fourth image representation including a second object (e.g., a factual image including the second object) to generate a fifth image representation not including the second object (e.g., a counterfactual image not including the second object). The computing device (or component thereof) can process the fifth image to generate a sixth image representation including the second object. The computing device (or component thereof) can compare the fourth image representation and the sixth image representation to determine a transitive consistency loss (e.g., loss determining from performing bi-directional editing of the counterfactual images and factual images) associated with the adjusted first machine learning system. The computing device (or component thereof) can adjust the parameters of the adjusted first machine learning system based on the transitive consistency loss. In another example, the bi-directional editing of the counterfactual images and the factual images can begin with the counterfactual image. In such an example, the fourth image representation does not include a second object, the fifth image representation includes the second object, and the sixth image representation does not include the second object.

FIG. 6 is an illustrative example of a deep learning neural network 600 that can be used by a machine learning system. An input layer 620 includes input data. In one illustrative example, the input layer 620 can include data representing the pixels of an input image or video frame. The neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. The neural network 600 further includes an output layer 624 that provides an output resulting from the processing performed by the hidden layers 622a, 622b, through 622n. In one illustrative example, the output layer 624 can provide a classification for an object in an input image or video frame. The classification can include a class identifying the type of object (e.g., a static object, a vehicle, a person, a dog, a cat, or other object).

The neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the hidden layers 622a, 622b, through 622n can transform the information of each input node by applying activation functions to the information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 624, at which an output is provided. In some cases, while nodes (e.g., node 626) in the neural network 600 are shown as having multiple output lines, a node has a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 624. In an example in which the neural network 600 is used to identify objects in images, the neural network 600 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 600 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 600 is trained well enough so that the weights of the layers are accurately tuned.

For the example of identifying objects in images, the forward pass can include passing a training image through the neural network 600. The weights are initially randomized before the neural network 600 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 600, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 600 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 600 can perform a backward pass by determining which inputs (weights) most contributed to the loss of the network and can adjust the weights so that the loss decreases and is eventually minimized.

A derivative of the loss with respect to the weights (denoted as dL/dW where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, w denotes the initial weight, and η denotes a learning rate. The learning rate can be set to any suitable value, with a high learning rate including larger weight updates and a lower value indicating smaller weight updates.

The neural network 600 can include any suitable deep network. One example includes a convolutional neural network (CNN), which includes an input layer and an output layer, with multiple hidden layers between the input and out layers. An example of a CNN is described below with respect to FIG. 6. The hidden layers of a CNN include a series of convolutional, nonlinear, pooling (for downsampling), and fully connected layers. The neural network 600 can include any other deep network other than a CNN, such as an autoencoder, a deep belief nets (DBNs), a Recurrent Neural Networks (RNNs), among others.

FIG. 7 is an illustrative example of a convolutional neural network 700 (CNN 700). The input layer 720 of the CNN 700 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 722a, an optional non-linear activation layer, a pooling hidden layer 722b, and fully connected hidden layers 722c to get an output at the output layer 724. While only one of each hidden layer is shown in FIG. 7, one of ordinary skill will appreciate that multiple convolutional hidden layers, non-linear layers, pooling hidden layers, and/or fully connected layers can be included in the CNN 700. As previously described, the output can indicate a single class of an object or can include a probability of classes that best describe the object in the image.

The first layer of the CNN 700 is the convolutional hidden layer 722a. The convolutional hidden layer 722a analyzes the image data of the input layer 720. Each node of the convolutional hidden layer 722a is connected to a region of nodes (pixels) of the input image called a receptive field. The convolutional hidden layer 722a can be considered as one or more filters (each filter corresponding to a different activation or feature map), with each convolutional iteration of a filter being a node or neuron of the convolutional hidden layer 722a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 722a. Each connection between a node and a receptive field for that node learns a weight and, in some cases, an overall bias such that each node learns to analyze its particular local receptive field in the input image. Each node of the hidden layer 722a will have the same weights and bias (called a shared weight and a shared bias). For example, the filter has an array of weights (numbers) and the same depth as the input. A filter will have a depth of 3 for the image or video frame example (according to three color components of the input image). An illustrative example size of the filter array is 5×5×3, corresponding to a size of the receptive field of a node.

The convolutional nature of the convolutional hidden layer 722a is due to each node of the convolutional layer being applied to its corresponding receptive field. For example, a filter of the convolutional hidden layer 722a can begin in the top-left corner of the input image array and can convolve around the input image. As noted above, each convolutional iteration of the filter can be considered a node or neuron of the convolutional hidden layer 722a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 722a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 722a.

The mapping from the input layer to the convolutional hidden layer 722a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 722a can include several activation maps in order to identify multiple features in an image. The example shown in FIG. 7 includes three activation maps. Using three activation maps, the convolutional hidden layer 722a can detect three different kinds of features, with each feature being detectable across the entire image.

In some examples, a non-linear hidden layer can be applied after the convolutional hidden layer 722a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 700 without affecting the receptive fields of the convolutional hidden layer 722a.

The pooling hidden layer 722b can be applied after the convolutional hidden layer 722a (and after the non-linear hidden layer when used). The pooling hidden layer 722b is used to simplify the information in the output from the convolutional hidden layer 722a. For example, the pooling hidden layer 722b can take each activation map output from the convolutional hidden layer 722a and generates a condensed activation map (or feature map) using a pooling function. Max-pooling is one example of a function performed by a pooling hidden layer. Other forms of pooling functions be used by the pooling hidden layer 722a, such as average pooling, L2-norm pooling, or other suitable pooling functions. A pooling function (e.g., a max-pooling filter, an L2-norm filter, or other suitable pooling filter) is applied to each activation map included in the convolutional hidden layer 722a. In the example shown in FIG. 7, three pooling filters are used for the three activation maps in the convolutional hidden layer 722a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 722a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 722a having a dimension of 24×24 nodes, the output from the pooling hidden layer 722b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 700.

The final layer of connections in the network is a fully-connected layer that connects every node from the pooling hidden layer 722b to every one of the output nodes in the output layer 724. Using the example above, the input layer includes 28×28 nodes encoding the pixel intensities of the input image, the convolutional hidden layer 722a includes 3×24×24 hidden feature nodes based on application of a 5×5 local receptive field (for the filters) to three activation maps, and the pooling layer 722b includes a layer of 3×12×12 hidden feature nodes based on application of max-pooling filter to 2×2 regions across each of the three feature maps. Extending this example, the output layer 724 can include ten output nodes. In such an example, every node of the 3×12×12 pooling hidden layer 722b is connected to every node of the output layer 724.

The fully connected layer 722c can obtain the output of the previous pooling layer 722b (which should represent the activation maps of high-level features) and determines the features that most correlate to a particular class. For example, the fully connected layer 722c layer can determine the high-level features that most strongly correlate to a particular class and can include weights (nodes) for the high-level features. A product can be computed between the weights of the fully connected layer 722c and the pooling hidden layer 722b to obtain probabilities for the different classes. For example, if the CNN 700 is being used to predict that an object in an image or video frame is a vehicle, high values will be present in the activation maps that represent high-level features of vehicles (e.g., two or four tires, a windshield, side view mirrors, etc.).

In some examples, the output from the output layer 724 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.9 0 0 0 0], the vector indicates that there is a 5% probability that the image is the third class of object (e.g., a person), an 80% probability that the image is the fourth class of object (e.g., a static object on a road or other driving surface), and a 9% probability that the image is the sixth class of object (e.g., a vehicle). The probability for a class can be considered a confidence level that the object is part of that class.

FIG. 8 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. A transformer 800 reduces the operations of learning dependencies by using an encoder 810 and a decoder 830 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 810 is composed of a stack of six identical layers and each layer has two sub-layers. The first sub-layer is a multi-head self-attention engine 812, and the second sub-layer is a fully connected feed-forward network 814. A residual connection (not shown) connects around each of the sub-layers followed by normalization.

In this example transformer 800, the decoder 830 is also composed of a stack of six 6 identical layers. The decoder also includes a masked multi-head self-attention engine 832, a multi-head attention engine 834 over the output of the encoder 810, and a fully connected feed-forward network 826. Each layer includes a residual connection (not shown) around the layer, which is followed by layer normalization. The masked multi-head self-attention engine 832 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 840 to encode positions because the model does not contain recurrence and convolution, and relative or absolute position of the tokens is needed. In the transformer 800, the positional encodings are added to the input embeddings at the bottom layer of the encoder 810 and the decoder 830. The positional encodings are summed with the embeddings because the positional encodings and embeddings have the same dimensions. A corresponding position decoder 850 is configured to decode the positions of the embeddings for the decoder 830.

In some aspects, the transformer 800 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 800 can process input sequences of variable length, making it well-suited for natural language processing tasks where input lengths can vary greatly. Additionally, the self-attention mechanism allows the transformer 800 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 9 illustrates an example computing system 900 of an example computing device which can implement the various techniques described herein. For example, the computing system 900 can implement the machine learning system shown in FIG. 4. The components of computing system 900 are shown in electrical communication with each other using connection 905, such as a bus. The example computing system 900 includes a processing unit (CPU or processor) 910 and computing device connection 905 that couples various computing device components including computing device memory 915, such as read only memory (ROM) 920 and random access memory (RAM) 925, to processor 910.

Computing system 900 can include a cache of high-speed memory connected directly with, in close proximity to, or integrated as part of processor 910. Computing system 900 can copy data from memory 915 and/or the storage device 930 to cache 912 for quick access by processor 910. In this way, the cache can provide a performance boost that avoids processor 910 delays while waiting for data. These and other modules can control or be configured to control processor 910 to perform various actions. Other computing device memory 915 may be available for use as well. Memory 915 can include multiple different types of memory with different performance characteristics. Processor 910 can include any general purpose processor and a hardware or software service, such as service 1932, service 2 934, and service 3 936 stored in storage device 930, configured to control processor 910 as well as a special-purpose processor where software instructions are incorporated into the processor design. Processor 910 may be a self-contained system, containing multiple cores or processors, a bus, memory controller, cache, etc. A multi-core processor may be symmetric or asymmetric.

To enable user interaction with the computing system 900, input device 945 can represent any number of input mechanisms, such as a microphone for speech, a touch-sensitive screen for gesture or graphical input, keyboard, mouse, motion input, speech and so forth. Output device 935 can also be one or more of a number of output mechanisms known to those of skill in the art, such as a display, projector, television, speaker device, etc. In some instances, multimodal computing devices can enable a user to provide multiple types of input to communicate with computing system 900. Communication interface 940 can generally govern and manage the user input and computing device output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAM s) 925, read only memory (ROM) 920, and hybrids thereof. Storage device 930 can include services 932, 934, 936 for controlling processor 910. Other hardware or software modules are contemplated. Storage device 930 can be connected to the computing device connection 905. In one aspect, a hardware module that performs a particular function can include the software component stored in a computer-readable medium in connection with the necessary hardware components, such as processor 910, connection 905, output device 935, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for image processing, the apparatus comprising: at least one memory; and at least one processor coupled to the at least one memory and configured to: process, using an encoder, a first image representation of a scene including an object to determine a first embedding associated with features of the first image representation; process, using the encoder, a second image representation of the scene not including the object to determine a second embedding associated with features of the second image representation; process, using a first machine learning system, the first embedding, the second embedding, a user prompt, and a mask associated with a pixel location of the object represented in the first image representation, to generate a third image representation of the scene not including the object; determine, based on a comparison of the second image representation and the third image representation, a diffusion loss; and adjust parameters of the first machine learning system based on the diffusion loss to provide an adjusted first machine learning system.

Aspect 2. The apparatus of Aspect 1, wherein the first embedding and the second embedding include a random distribution of noise applied to each embedding.

Aspect 3. The apparatus of any of Aspects 1 to 2, wherein the at least one processor is further configured to: process, using a second machine learning system, the first image representation to identify the object from the scene; and generate the mask based on the pixel location of the object represented in the first image representation.

Aspect 4. The apparatus of any of Aspects 1 to 2, wherein the first machine learning system includes a diffusion machine learning system using U-Net neural network architecture.

Aspect 5. The apparatus of any of Aspects 1 to 2, wherein the first machine learning system is trained using a plurality of user prompts including user prompts requesting removal of objects from images and user prompts not requesting removal of the objects from the images.

Aspect 6. The apparatus of any of Aspects 1 to 5, wherein a majority of the user prompts used to train the first machine learning system do not request removal of the objects from the images.

Aspect 7. The apparatus of any of Aspects 1 to 2, wherein the at least one processor is further configured to: process, using the adjusted first machine learning system, a fourth image representation including a second object, to generate a fifth image representation not including the second object; process, using the adjusted first machine learning system, the fifth image representation to generate a sixth image representation including the second object; determine, based on a comparison of the fourth image representation and the sixth image representation, a transitive consistency loss associated with the adjusted first machine learning system; and adjust the parameters of the adjusted first machine learning system based on the transitive consistency loss.

Aspect 8. The apparatus of any of Aspects 1 to 2, wherein the at least one processor is further configured to: process, using the adjusted first machine learning system, a fourth image representation, to generate a fifth image representation including a second object not included in the fourth image representation; process, using the adjusted first machine learning system, the fifth image representation to generate a sixth image representation not including the second object; determine, based on a comparison of the fourth image representation and the sixth image representation, a transitive consistency loss associated with the adjusted first machine learning system; and adjust the parameters of the adjusted first machine learning system based on the transitive consistency loss.

Aspect 9. The apparatus of any of Aspects 1 to 2, wherein the first machine learning system is trained using on-device training.

Aspect 10. An apparatus for image processing, the apparatus comprising: at least one memory; and at least one processor coupled to the at least one memory and configured to: process a first image of a first scene including a first object and a user prompt requesting removal of the first object from the first image using a first machine learning system, wherein the first machine learning system is trained based on a comparison of a first image representation and a second image representation, wherein the first image representation represents a second scene not including a second object and the second image representation is a predicted representation of the first image representation based on an image including the second object, a second user prompt, and a mask, and wherein the comparison is used to determine a diffusion loss to train the first machine learning system; and generate a second image, the second image including the first scene with the first object removed.

Aspect 11. The apparatus of Aspect 10, wherein the first image and the second image include a random distribution of noise applied to the first image and the second image.

Aspect 12. A method for image processing, the method comprising: processing, using an encoder, a first image representation of a scene including an object to determine a first embedding associated with features of the first image representation; processing, using the encoder, a second image representation of the scene not including the object to determine a second embedding associated with features of the second image representation; processing, using a first machine learning system, the first embedding, the second embedding, a user prompt, and a mask associated with a pixel location of the object represented in the first image representation, to generate a third image representation of the scene not including the object; determining, based on a comparison of the second image representation and the third image representation, a diffusion loss; and adjusting parameters of the first machine learning system based on the diffusion loss to provide an adjusted first machine learning system.

Aspect 13. The method of Aspect 12, wherein the first embedding and the second embedding include a random distribution of noise applied to each embedding.

Aspect 14. The method of any of Aspects 12 to 13, further comprising: processing, using a second machine learning system, the first image representation to identify the object from the scene; and generating the mask based on the pixel location of the object represented in the first image representation.

Aspect 15. The method of any of Aspects 12 to 13, wherein the first machine learning system includes a diffusion machine learning system using U-Net neural network architecture.

Aspect 16. The method of any of Aspects 12 to 13, wherein the first machine learning system is trained using a plurality of user prompts including user prompts requesting removal of objects from images and user prompts not requesting removal of the objects from the images.

Aspect 17. The method of any of Aspects 12 to 16, wherein a majority of the user prompts used to train the first machine learning system do not request removal of the objects from the images.

Aspect 18. The method of any of Aspects 12 to 13, further comprising: processing, using the adjusted first machine learning system, a fourth image representation including a second object, to generate a fifth image representation not including the second object; processing, using the adjusted first machine learning system, the fifth image representation to generate a sixth image representation including the second object; determining, based on a comparison of the fourth image representation and the sixth image representation, a transitive consistency loss associated with the adjusted first machine learning system; and adjusting the parameters of the adjusted first machine learning system based on the transitive consistency loss.

Aspect 19. The method of any of Aspects 12 to 13, further comprising: processing, using the adjusted first machine learning system, a fourth image representation, to generate a fifth image representation including a second object not included in the fourth image representation; processing, using the adjusted first machine learning system, the fifth image representation to generate a sixth image representation not including the second object; determining, based on a comparison of the fourth image representation and the sixth image representation, a transitive consistency loss associated with the adjusted first machine learning system; and adjusting the parameters of the adjusted first machine learning system based on the transitive consistency loss.

Aspect 20. The method of any of Aspects 12 to 13, wherein the first machine learning system is trained using on-device training.

Aspect 21. A method for image processing, the method comprising: processing a first image of a first scene including a first object and a user prompt requesting removal of the first object from the first image using a first machine learning system, wherein the first machine learning system is trained based on a comparison of a first image representation and a second image representation, wherein the first image representation represents a second scene not including a second object and the second image representation is a predicted representation of the first image representation based on an image including the second object, a second user prompt, and a mask, and wherein the comparison is used to determine a diffusion loss to train the first machine learning system; and generating a second image, the second image including the first scene with the first object removed.

Aspect 22. The method of Aspect 21, wherein the first embedding and the second embedding include a random distribution of noise applied to each embedding.

Aspect 23. A non-transitory computer-readable medium having stored thereon instructions that, when executed by at least one processor, cause the at least one processor to perform one or more of operations according to any of Aspects 12 to 22.

Aspect 24. An apparatus for image processing comprising one or more means for performing operations according to any of Aspects 12 to 22.

What is claimed:

1. An apparatus for image processing, the apparatus comprising:
at least one memory; and
at least one processor coupled to the at least one memory and configured to:
process, using an encoder, a first image representation of a scene including an object to determine a first embedding associated with features of the first image representation;
process, using the encoder, a second image representation of the scene not including the object to determine a second embedding associated with features of the second image representation;
process, using a first machine learning system, the first embedding, the second embedding, a user prompt, and a mask associated with a pixel location of the object represented in the first image representation, to generate a third image representation of the scene not including the object;
determine, based on a comparison of the second image representation and the third image representation, a diffusion loss; and
adjust parameters of the first machine learning system based on the diffusion loss to provide an adjusted first machine learning system.

2. The apparatus of claim 1, wherein the first embedding and the second embedding include a random distribution of noise applied to each embedding.

3. The apparatus of claim 1, wherein the at least one processor is further configured to:
process, using a second machine learning system, the first image representation to identify the object from the scene; and
generate the mask based on the pixel location of the object represented in the first image representation.

4. The apparatus of claim 1, wherein the first machine learning system includes a diffusion machine learning system using U-Net neural network architecture.

5. The apparatus of claim 1, wherein the first machine learning system is trained using a plurality of user prompts including user prompts requesting removal of objects from images and user prompts not requesting removal of the objects from the images.

6. The apparatus of claim 5, wherein a majority of the user prompts used to train the first machine learning system do not request removal of the objects from the images.

7. The apparatus of claim 1, wherein the at least one processor is further configured to:
process, using the adjusted first machine learning system, a fourth image representation including a second object, to generate a fifth image representation not including the second object;
process, using the adjusted first machine learning system, the fifth image representation to generate a sixth image representation including the second object;
determine, based on a comparison of the fourth image representation and the sixth image representation, a transitive consistency loss associated with the adjusted first machine learning system; and
adjust the parameters of the adjusted first machine learning system based on the transitive consistency loss.

8. The apparatus of claim 1, wherein the at least one processor is further configured to:
process, using the adjusted first machine learning system, a fourth image representation, to generate a fifth image representation including a second object not included in the fourth image representation;
process, using the adjusted first machine learning system, the fifth image representation to generate a sixth image representation not including the second object;
determine, based on a comparison of the fourth image representation and the sixth image representation, a transitive consistency loss associated with the adjusted first machine learning system; and
adjust the parameters of the adjusted first machine learning system based on the transitive consistency loss.

9. The apparatus of claim 1, wherein the first machine learning system is trained using on-device training.

10. An apparatus for image processing, the apparatus comprising:
at least one memory; and
at least one processor coupled to the at least one memory and configured to:
process a first image of a first scene including a first object and a user prompt requesting removal of the first object from the first image using a first machine learning system, wherein the first machine learning system is trained based on a comparison of a first image representation and a second image representation, wherein the first image representation represents a second scene not including a second object and the second image representation is a predicted representation of the first image representation based on an image including the second object, a second user prompt, and a mask, and wherein the comparison is used to determine a diffusion loss to train the first machine learning system; and
generate a second image, the second image including the first scene with the first object removed.

11. The apparatus of claim 10, wherein the first image and the second image include a random distribution of noise applied to the first image and the second image.

12. A method for image processing, the method comprising:
processing, using an encoder, a first image representation of a scene including an object to determine a first embedding associated with features of the first image representation;
processing, using the encoder, a second image representation of the scene not including the object to determine a second embedding associated with features of the second image representation;
processing, using a first machine learning system, the first embedding, the second embedding, a user prompt, and a mask associated with a pixel location of the object represented in the first image representation, to generate a third image representation of the scene not including the object;
determining, based on a comparison of the second image representation and the third image representation, a diffusion loss; and
adjusting parameters of the first machine learning system based on the diffusion loss to provide an adjusted first machine learning system.

13. The method of claim 12, wherein the first embedding and the second embedding include a random distribution of noise applied to each embedding.

14. The method of claim 12, further comprising:
processing, using a second machine learning system, the first image representation to identify the object from the scene; and
generating the mask based on the pixel location of the object represented in the first image representation.

15. The method of claim 12, wherein the first machine learning system includes a diffusion machine learning system using U-Net neural network architecture.

16. The method of claim 12, wherein the first machine learning system is trained using a plurality of user prompts including user prompts requesting removal of objects from images and user prompts not requesting removal of the objects from the images.

17. The method of claim 16, wherein a majority of the user prompts used to train the first machine learning system do not request removal of the objects from the images.

18. The method of claim 12, further comprising:
processing, using the adjusted first machine learning system, a fourth image representation including a second object, to generate a fifth image representation not including the second object;
processing, using the adjusted first machine learning system, the fifth image representation to generate a sixth image representation including the second object;
determining, based on a comparison of the fourth image representation and the sixth image representation, a transitive consistency loss associated with the adjusted first machine learning system; and
adjusting the parameters of the adjusted first machine learning system based on the transitive consistency loss.

19. The method of claim 12, further comprising:
processing, using the adjusted first machine learning system, a fourth image representation, to generate a fifth image representation including a second object not included in the fourth image representation;
processing, using the adjusted first machine learning system, the fifth image representation to generate a sixth image representation not including the second object;
determining, based on a comparison of the fourth image representation and the sixth image representation, a transitive consistency loss associated with the adjusted first machine learning system; and
adjusting the parameters of the adjusted first machine learning system based on the transitive consistency loss.

20. The method of claim 12, wherein the first machine learning system is trained using on-device training.
